(19) United States
(12) Patent Application Publication
(10) Pub. No.: US 2007/0227070 A1
(43) Pub. Date: Oct. 4, 2007

(54) Staged modular hydrocarbon reformer with internal temperature management

(76) Inventors: Bernhard A. Fischer, Rochester, NY (US); Diane M. England, Bloomfield, NY (US)

Correspondence Address: DELPHI TECHNOLOGIES, INC., M/C 480-410-202, PO BOX 5052, TROY, MI, 48007, US

(21) Appl. No.: 11/395,672

(22) Filed: Mar. 31, 2006

(51) Int. Cl. B01J 8/00

(52) U.S. Cl. 48/127.9

(57) ABSTRACT

A CPOx hydrocarbon reformer comprising a plurality of sequential reforming stages for generating reformate. The first stage comprises adjacent active and inactive flow channels. Only a portion of the surface is provided with catalyst. The active channels have low catalytic activity such that about one-quarter of the reactants passing through the first stage is catalyzed. Reactants flowing through the inactive channels cool the active channels, preventing bed erosion. The fast exothermic combustion reaction near the front edge of the catalyst produces largely water and carbon dioxide but little hydrogen. Endothermic reactions in the following stages produce hydrogen and carbon monoxide while consuming water, carbon dioxide, and the remaining hydrocarbon fuel and oxygen using steam- and dry-reforming. Preferably, the intermediate stage reacts about one-half of the fuel. The last stage is fully coated to react the remainder of the fuel, and catalyst activity is increased.

The present invention relates to hydrocarbon reformers for producing fuel for fuel cells; more particularly, to such a reformer comprising a plurality of sequential reforming stages; and most particularly, to a staged reformer system wherein reforming is controlled and limited in sequential stages to prevent thermal degradation of the reformer.

### BACKGROUND OF THE INVENTION

Partial catalytic oxidizing (CPOx) reformers are well known in the art as devices for converting hydrocarbons to reformate containing hydrogen (H₂) and carbon monoxide (CO) as fuel for fuel cell systems, and especially for solid oxide fuel cell (SOFC) systems. CPOx, in general, is a two-stage chemical reaction that includes a fast exothermic combustion reaction followed by slower endothermic fuel reforming. The exothermic reactions are self-sustaining, even self-accelerating in a form of “run-away” chemical reactions. The higher the reaction rate, the higher the temperature; and the higher the temperature, the higher the reaction rate.

Prior art CPOx reformers typically comprise a catalyst bed formed of a durable inert substrate coated with an active catalytic wash coat. The substrate is typically porous, presenting a large surface area for catalysis.

A serious problem for prior art catalyst beds is that intense exothermic catalysis occurs at the leading edge of the bed where the concentration of reactants entering the reformer is highest and the dispersal of heat is lowest, causing rapid exothermic heat release and heat buildup which results in unacceptably elevated substrate, washcoat, and catalyst temperatures along the leading edge. Heat is thereby released directly into the catalyst material, the substrate, and the fluid stream, supporting the subsequent endothermic reforming processes. It is believed that temperatures at the beginning of the catalyst bed of a prior art reformer can reach more than 1750° C. because of this rapid exothermic release. For example, at an oxygen/carbon (O/C) ratio of 1.16, the equilibrium temperature at the front edge of a catalyst bed reaches 1750° C. for isooctane under adiabatic conditions, and as much as 1600° C. for methane, at reactant inlet temperatures of 150° C. During sustained use of the reformer, the catalyst bed is progressively eroded, ablated, or otherwise thermally deactivated along the leading edge, resulting in a progressively smaller bed and eventual failure of the reformer.

As compared to steam or autothermal reforming systems, CPOx reformers offer compact and lightweight design, reduced reformer length, short residence time, high space velocity, and small space-time, and therefore reduced cost and efficient packaging. However, these benefits are partially offset by generally lower system efficiency because part of the fuel is consumed to drive the fuel processing reaction and the necessity to run overall higher O/C ratios. For efficiency reasons, CPOx should operate at as low an air/fuel (O/C) ratio as possible to maximize reforming efficiency while retaining safety margin from carbon formation on the catalyst. One way to achieve this is by increasing the reactant temperature and decreasing O/C ratio prior to reforming.

It is difficult to remove heat from the front edges of the catalyst and substrate to control the exothermic reactions, which area dominates but a small part geometrically of a reformer. This leads to a major problem in design, durability, and performance of prior art CPOx reformers.

It is known in the combustion arts to fabricate a catalytic combustor from a folded, crimped, or chopped metal strip coated with catalyst on only one side. See, for example, U.S. Pat. Nos. 5,202,303; 5,328,359; 5,346,389; and 5,406,704, the relevant disclosures of which are incorporated herein by reference. Such hydrocarbon combustors are known to reduce the overall rate of reaction by a) providing reactive channels comprising only 50% of the otherwise active surface area, and b) providing inherent cooling channels comprising the other 50% for passage of non-reacted reactants adjacent to the reactive channels. A reactor made by this method has an extended useful life in part because it does not become so hot that the catalyst becomes deactivated. Additional combustor stages, which may or may not be catalytic, are provided to drive previously non-reacted reactants to complete combustion, resulting in incombustible gases, principally carbon dioxide and water. Such combustors typically employ a stoichometric excess of oxygen and are useful for providing high-temperature gases to drive devices such as gas turbines, for example.

Although similar in some respects to the combustors just described, CPOx catalytic reformers cannot avail themselves of the exact prior art because a CPOx reformer operates by definition on a sub-stoichometric oxygen budget and is intended to produce combustible gases, e.g., hydrogen and carbon monoxide, that represent only partial oxidation of the starting fuel, e.g., methane or other hydrocarbon. Thus, means must be provided to control inherently not only the combustive oxidation occurring in a first reformer stage but also the partial oxidation provided in one or more succeeding stages.

What is needed in the hydrocarbon reforming arts is means for providing high-efficiency, high-throughput, durable, and long-life CPOx reforming without creating unacceptably high temperatures at the entrance to the reformer.

It is a principal object of the present invention to provide high-efficiency, high-throughput, durable, and long-life CPOx reforming.

### SUMMARY OF THE INVENTION

Briefly described, a CPOx hydrocarbon reformer in accordance with the invention comprises a plurality of sequential reforming stages, preferably three, that may or may not be separated by non-reforming mixing spaces therebetween.

The first reforming stage is arranged to have a plurality of adjacent active and inactive flow channels such that only a predetermined portion of the substrate surface available to hydrocarbon fuel and air is provided with catalyst. Preferably, the catalytic materials in active channels have relatively low catalytic activity such that not all of the fuel and air passing through the first stage active channels is catalyzed. Fuel and air flowing through the inactive channels cool the catalyst bed of the active channels, thereby preventing thermal excess in the first stage and consequent bed erosion. Preferably, this stage reacts about one-quarter of the fuel. The fast exothermic combustion reaction near the front edge of the catalyst in the active channels produces largely water and carbon dioxide, but little hydrogen, while consuming some of the hydrocarbon and oxygen. Endothermic reactions in the following stages produce hydrogen and carbon monoxide while consuming water, carbon dioxide, and the remaining hydrocarbon fuel and oxygen in a combination of steam- and dry-reforming processes.

The second stage is also preferably arranged to have a plurality of adjacent active and inactive flow channels; however, the activity of the catalytic material is increased as are the length of the stage and residence time of the reactants. Preferably, this stage reacts about one-half of the fuel.

The third stage is fully coated such that all channels are catalytically active, which stage reacts the remainder of the fuel.

### BRIEF DESCRIPTION OF THE DRAWINGS

The present invention will now be described, by way of example, with reference to the accompanying drawings, in which:

FIG. 1 is a schematic elevational longitudinal cross-sectional view of a prior art single-stage CPOx reformer;

FIG. 2 is a graph showing temperature longitudinally through the prior art single-stage CPOx reformer shown in FIG. 1, when reforming isooctane;

FIG. 3 is a graph like that shown in FIG. 2 when the hydrocarbon fuel is methane;

FIG. 4 is a view like that shown in FIG. 1, showing progressive destruction during use of the leading edge of a prior art catalyst having a metal substrate;

FIG. 5 is a view like that shown in FIG. 4 for a prior art catalyst having a ceramic substrate;

FIG. 6 is a schematic elevational longitudinal cross-sectional view of a two-stage CPOx reformer in accordance with the invention;

FIG. 7 is a schematic elevational longitudinal cross-sectional view of a three-stage CPOx reformer in accordance with the invention;

FIG. 8 is a schematic drawing showing formation of a first catalytic bed in accordance with the invention by using a plurality of layered corrugated sheets;

FIG. 9 is a schematic drawing showing formation of a second catalytic bed in accordance with the invention by alternating corrugated and non-corrugated sheets;

FIG. 10 is a schematic drawing showing the arrangement shown in FIG. 8 rolled into a spiral catalytic bed; and

FIG. 11 is a schematic drawing showing the arrangement shown in FIG. 8 folded into a stacked catalytic bed having a cylindrical cross-sectional shape.

### DESCRIPTION OF THE PREFERRED EMBODIMENTS

The distinctions and benefits of the present invention may be better appreciated by first considering the elements and limitations of a prior art catalytic reformer.

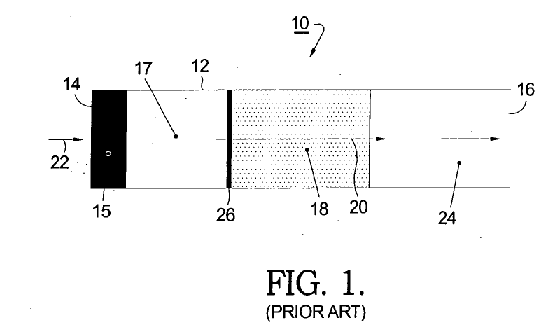

Referring to FIGS. 1 through 5, a prior art hydrocarbon catalytic reformer 10 includes a housing 12 having an inlet 14 and outlet 16. Disposed within housing 12 is a catalyst bed 18 having porosity in at least a longitudinal direction 20. Bed 18 typically includes a durable non-catalytic substrate coated with a washcoat including or supporting catalytic means. The substrate is formed typically of either a metal or a ceramic, as discussed further below. Conventional means for controlling overall temperature, fuel flow rate, air flow rate, and the like are assumed but not shown in FIG. 1.

In operation, a mixture 22 of hydrocarbon and oxygen, typically in the form of air, is introduced into reformer 10 through inlet 14 and thence through a mixture preparation unit 15 and fluid mixing zone 17. The mixture then is passed through catalyst bed 18 wherein the hydrocarbon fuel and air are converted to a reformate 24 comprising a mixture of molecular hydrogen and carbon monoxide.

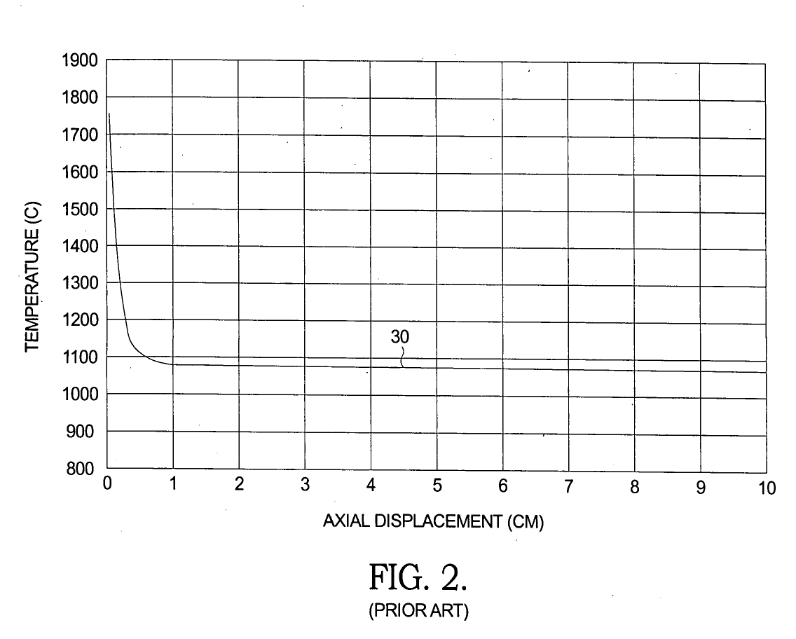

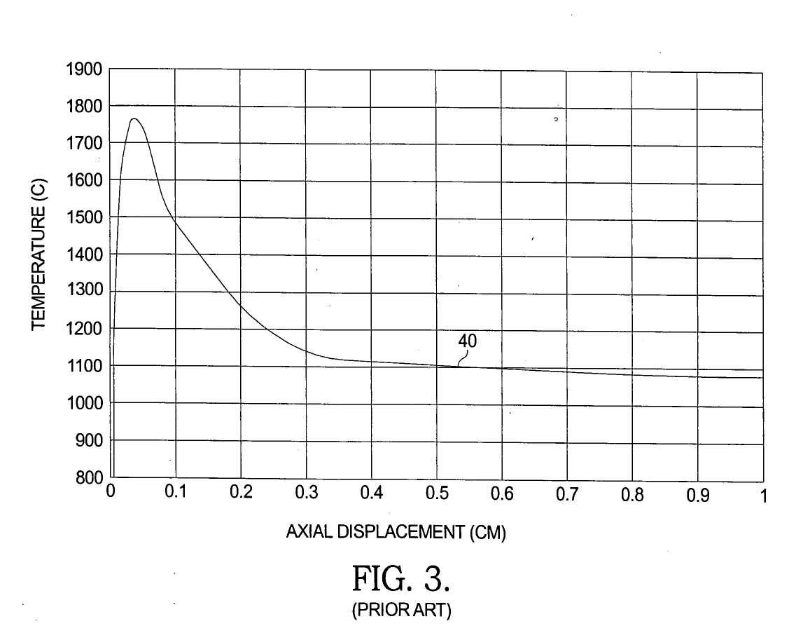

As noted above, a shortcoming of a prior art reformer such as reformer 10 is that the leading edge 26 of catalyst bed 18 becomes severely overheated by intensely exothermic catalytic reaction of the hydrocarbon and oxygen. FIGS. 2 and 3 show the intense onset heating of the catalyst bed for isooctane (FIG. 2, curve 30) and methane (FIG. 3, curve 40).

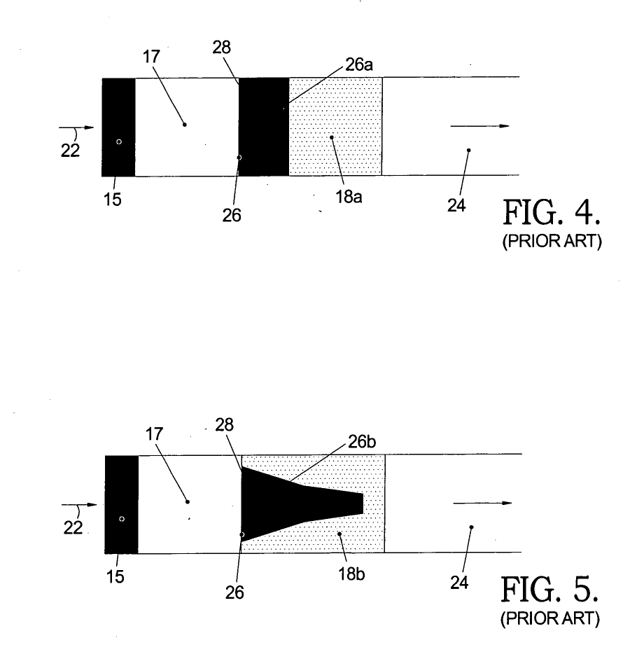

Referring to FIGS. 4 and 5, the impact of catalyst substrate material is shown on a prior art CPOx reformer. The catalyst bed 18a shown in FIG. 4 includes a metal substrate, whereas the catalyst bed 18b shown in FIG. 5 includes a ceramic substrate. Higher temperatures prevail within substrates formed of relatively low-conductivity materials such as ceramics, whereas generally lower temperatures prevail within substrates formed of relatively high-conductivity materials, for example, NiAl alloy. The metal substrate having high conductivity acts to spread out the heat generated by the exothermic CPOx reaction, creating a uniform heat front, whereas the ceramic substrate having low conductivity allows the heat front to propagate nonuniformly into the catalyst bed. In either case, the catalyst bed suffers thermal erosion over time of use, resulting in a recession of leading bed edge 26 to a new bed edge 26a or 26b which continues to recede with continued use of the reformer, leaving a burned-out catalyst zone 28. The over-temperature situation affects a) the catalytic activity of the reforming catalyst due to sintering of the washcoat and subsequent loss of surface area; b) adhesion of the washcoat to the metallic substrate due to thermal stresses; and, c) structural integrity of the substrate as most useful alloys melt in the 1300° C.-1500° C. temperature range. As the catalyst and substrate are progressively destroyed, the exothermic front 26a, 26b moves downstream through the entire catalyst bed, leading to total failure of the reformer.

The only way to prevent such burn-out failure is to provide cooling of the leading edge of the catalyst bed. Active cooling, for example, by circulation of a coolant through the bed, is impractical and also is undesirable because it removes heat from the system which is beneficial in the later endothermic reforming stages and thus reduces the thermal efficiency of the reformer.

What is needed is means for inherent passive cooling of the leading edge both a) by postponing some portion of the combustion and reforming that presently occurs at the leading edge of the catalyst bed in the prior art CPOx reformer 10 and b) by reducing the intensity of the allowed combustion and reforming.

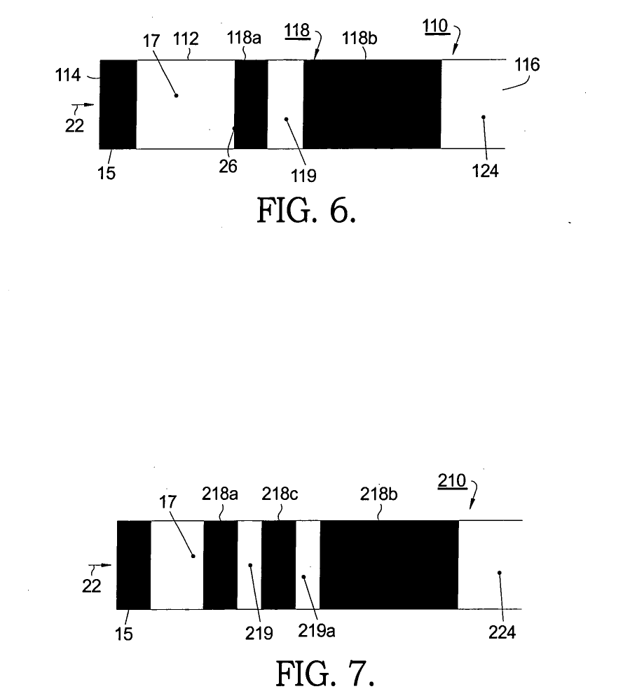

Referring to FIG. 6, a first embodiment 110 of a hydrocarbon reformer improved in accordance with the invention also comprises a housing 112 having an inlet 114 and outlet 116. A catalyst bed 118 is divided into first and last stages 118a, 118b, preferably but not necessarily separated by an intermediate chamber.

Preferably, first stage 118a comprises a metal catalyst substrate and last stage 118b comprises a ceramic catalyst substrate. The stage 118b substrate is preferably a cast honeycomb ceramic monolith as is well known in the art. Reactants 22 enter first stage 118a having been preheated conventionally to a preferable temperature of up to 500° C. to enable lower O/C ratios while retaining resistance to carbon formation. First stage 118a is formed as described below such that coated catalytic and non-catalytic flow channels are interlaced generally in the flow direction. Catalytic reactions occur in only the coated (“hot”) catalytic channels, leading to a strong temperature increase in those channels. However, the non-coated (“cold”) channels do not promote chemical reaction and thus act as cooling channels in the manner of a heat exchanger such that the fluid temperatures in the hot channels are suppressed below temperatures seen in prior art reformer catalyst beds 18 and the metal substrate temperatures remain well below distress temperatures. Thus it is seen that hot gas, cold channels, and metal temperatures can be controlled by the size and arrangement of the coated and non-coated channels as well as by selective catalytic coating.

In a currently preferred embodiment, the catalytic material coating in the first stage active channels is not as fully loaded with catalyst metal per unit area as a prior art CPOx reformer 10, nor as a last stage 118b as described below, to further suppress catalytic activity in first stage 118a. Preferably, first stage 118a reacts less than one-half of the fuel in mixture 22. A preferred catalytic material for first stage 118a includes Rainey nickel and/or a noble metal, depending upon the fuel. A preferred catalyst carrier is hexa-aluminate or a highly-stabilized alumina, which is desirable for high washcoat surface area and catalyst dispersion stability.

The function of first stage 118a is to carry out sufficient combustion early in the stage (without damaging the catalyst bed) and exothermic reforming to provide a hot mixture of hydrocarbon, H₂O, CO, CO₂, N₂, and H₂ to the latter portions of first stage 118a and last stage 118b wherein a mixture of dry (exothermic) and wet (endothermic) reforming is carried out to produce a reformate 124 comprising ideally only N₂, CO, and H₂.

Gases from the first stage hot and cold channels preferably mix at the end of first stage 118a in intermediate chamber 119. Initial temperatures in last stage 118b are substantially lower than in first stage 118a because much heat has already been removed from the system by endothermic reforming in the latter portions of first stage 118a. Last stage 118b is formed having a plurality of parallel flow channels similar to the structure of first stage 118a, and all the flow channels are coated with noble metal catalyst to endothermically react the remaining hydrocarbon fuel and complete the conversion of water and CO₂ into H₂ and CO. A currently preferred catalyst may include dopants comprising rhodium, platinum, and iridium, and a currently preferred washcoat is a high performing alumina matrix.

Referring to FIG. 7, a currently preferred embodiment 210 of a CPOx reformer improved in accordance with the invention comprises three stages, including an intermediate stage 218c and another intermediate chamber 219a similar to first intermediate chamber 219 disposed between first and last stages 218a,218b as shown for embodiment 110 in FIG. 6. Remixing of the reactants and reaction products occurs in second intermediate chamber 219a prior to entry into last stage 218b. The catalyst bed is formed of parallel channels as in the first and last stages, and as in the first stage only a portion (preferably one-half) of the flow channels are catalytically active. However, preferably the noble metal loading of the catalytic material is increased over that in first stage 118a to help maintain (by exothermic combustion) the temperatures required for endothermic reforming through the second and third stages, but preferably is less than the noble metal loading in the last stage. Preferably, intermediate stage 218c reacts approximately one-half of the hydrocarbon fuel entered to first stage 218a in mixture 22. A currently preferred catalytic material may be doped with rhodium, iridium, or combination thereof, and a currently preferred washcoat is a stabilized alumina matrix.

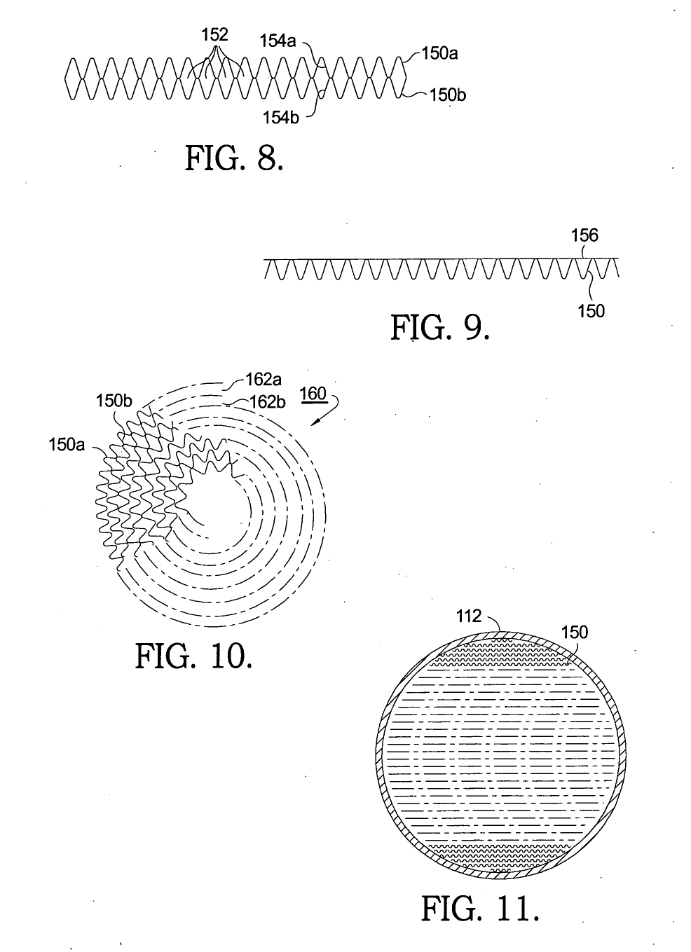

Referring to FIGS. 8 through 11, structures for any or all of first, intermediate, and last stages 218a, 218c, 218b and first and last stages 118a, 118b may be readily formed by configuring metal substrates in any of several configurations, as is well known in the prior art and preferably as disclosed in great structural detail in the incorporated US patent references on total catalytic combustion. One or both surfaces of flat metal sheet stock may be coated to a catalytic washcoat and loaded with the appropriate noble metals. After corrugation, the catalytic stock may be folded or chopped and layered, either with or without non-corrugated stock interleaved, to create the plurality of flow channels described above. Catalytic stages of a CPOx reformer in accordance with the invention may be formed by selection of which surfaces to coat, how heavily to load the catalyst with noble metals, and how to corrugate and fold the metal substrates.

FIG. 8 shows end views of two corrugated sheets 150a, 150b joined together with their corrugations 180° out of phase to form flow channels 152 therebetween. It will be seen that when both of the opposing surfaces 154a, 154b of the sheets are coated with catalyst, the flow channels will be fully active; when only one of the opposing surfaces is coated, the flow channels will be only half-active; and when neither of the opposing surfaces is coated, the flow channels will be catalytically inactive. In addition, as described above, the noble metal loading of the coated catalyst may be varied to further fine-tune the catalytic capabilities of the assembled reformer stage.

Referring to FIG. 10, corrugated sheets 150a, 150b are shown rolled into a double-spiral reformer stage 160 wherein the corrugations are generally out of phase. Note that full contact and strict phase relationship between the corrugations is not necessary because each spiral convolution (e.g. 162a) is entirely independent of the other (e.g. 162b). Sheets 150a, 150b may also be arranged in a stacked relationship, or a single corrugated sheet 150 may be folded within a housing 112 as shown in FIG. 11 to form any desired cross-sectional shape for CPOx reformers 110, 210.

Referring to FIG. 9, a reformer may also be configured of alternating corrugated sheets 150 and flat sheets 156, with the same surface coating considerations just described.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A catalytic partial oxidation (CPOx) reformer for reforming hydrocarbon fuel and oxygen into reformate containing hydrogen and carbon monoxide, comprising a plurality of reforming stages arranged in flow sequence, each of said stages having a reforming bed including a plurality of flow channels having a surface for supporting a catalytic material,
wherein in a first stage a portion of said surface of said first reforming bed is free of catalytic material such that fewer than all of said first stage flow channels are catalytically active, and
wherein in a last stage all of said surface of said last reforming bed is covered with catalytic material such that all of said last stage flow channels are catalytically active.

2. A reformer in accordance with claim 1 wherein said catalytic material in said first stage is less catalytically active than said catalytic material in said last stage.

3. A reformer in accordance with claim 2 wherein said first stage catalytic material is less heavily doped with noble metals than is said last stage catalytic material.

4. A reformer in accordance with claim 1 further comprising at least one intermediate reforming stage disposed between said first and last stages.

5. A reformer in accordance with claim 4 wherein said catalytic material in said intermediate stage is more catalytically active than said catalytic material in said first stage and is less catalytically active than said catalytic material in said last stage.

6. A reformer in accordance with claim 1 wherein said reforming bed in at least one of said stages includes a spiral-wound corrugated metal sheet.

7. A reformer in accordance with claim 1 wherein said reforming bed in at least one of said stages includes a ceramic substrate.

8. A reformer in accordance with claim 1 further comprising at least one intermediate mixing chamber between adjacent of said plurality of stages.

9. A reformer in accordance with claim 1 wherein catalytic activity is said first stage and catalytic activity in said last stage are arranged such that exothermic reforming occurs in said first stage and endothermic reforming occurs in said last stage.

10. A reformer in accordance with claim 1 wherein said catalyst in said first stage includes Rainey nickel and wherein catalysts in successive of said plurality of stages include noble metals.

11. A reformer in accordance with claim 10 wherein said noble metals are selected from the group consisting of rhodium, iridium, platinum, and combinations thereof.
